(19) United States
(12) Patent Application Publication
(10) Pub. No.: US 2023/0169741 A1
(43) Pub. Date: Jun. 1, 2023

(54) METHOD OF SEPARATING TERRAIN MESH MODEL AND DEVICE FOR PERFORMING THE SAME

(71) Applicant: Electronics and Telecommunications Research Institute, Daejeon (KR)

(72) Inventors: Yun Ji BAN, Daejeon (KR); Hye-sun KIM, Daejeon (KR)

(73) Assignee: Electronics and Telecommunications Research Institute, Daejeon (KR)

(21) Appl. No.: 17/866,950

(22) Filed: Jul. 18, 2022

(30) Foreign Application Priority Data
Nov. 29, 2021 (KR) 10-2021-0166738

(51) Int. Cl. G06T 19/20; G06T 17/20; G06T 7/11; G06T 17/05

(52) U.S. Cl. CPC G06T 19/20; G06T 17/20; G06T 7/11; G06T 17/05; G06T 2219/2008; G06T 2207/10016; G06T 2207/20081; G06T 2207/20092

(57) ABSTRACT

Disclosed is a separation method including obtaining a mesh model separated into an object unit, based on a segmentation image extracting an object included in an image sequence, updating second label information of the separated mesh model, based on first label information of the segmentation image and a user's input, and updating the separated mesh model, based on the updated second label information, in which an integrated mesh model before being separated into an object unit is generated from the image sequence.

### CROSS-REFERENCE TO RELATED APPLICATION(S)

This application claims the priority benefit of Korean Patent Application No. 10-2021-0166738 filed on Nov. 29, 2021, in the Korean Intellectual Property Office, the disclosure of which is incorporated herein by reference for all purposes.

### BACKGROUND

### 1. Field

One or more example embodiments relate to a method of separating a terrain mesh model and a device for performing the same.

### 2. Description of Related Art

The recent, growing popularity of metaverse has driven the advancement of a three-dimensional (3D) restoration technique and increased the need for a virtual terrain model. A 3D restored virtual terrain model is a single connected mesh model and has low usability. Deep learning technology may be used to separate a 3D restored mesh model (e.g., a 3D mesh model) into an object unit. The deep learning technology for separating the 3D mesh model into an object unit may include technology for receiving an input of a 3D mesh model as training data is received and technology for receiving an input of a two-dimensional (2D) image separated into an object unit as training data.

The above description is information the inventor(s) acquired during the course of conceiving the present disclosure, or already possessed at the time, and is not necessarily art publicly known before the present application was filed.

### SUMMARY

Deep learning technology is a process of obtaining a result by using a model after training the model with training data, and thus, securing of the training data and the accuracy of the training data are important. However, deep learning technology for receiving an input of a three-dimensional (3D) mesh model as training data and separating the 3D mesh model into an object unit may not secure enough training data, and thus, the accuracy of a result therefrom may decrease. In deep learning technology for receiving an input of a two-dimensional (2D) image separated into an object unit as training data, a form of the training data is dissimilar to a 3D mesh model, and thus, accuracy may decrease. Accordingly, deep learning technology for separating a 3D mesh model into an accurate object unit by securing enough accurate training data may be needed.

An aspect provides technology for separating a 3D mesh model into an object unit, based on a 3D mesh model and a 2D image separated after deep learning into an object unit.

Another aspect also provides technology for generating an image corresponding to a 3D mesh model separated into an object unit as training data of deep learning.

However, the technical aspects are not limited to the aspects above, and there may be other technical aspects.

According to an aspect, there is provided a separation method including: obtaining a mesh model separated into an object unit, based on a segmentation image extracting an object included in an image sequence; updating second label information of the separated mesh model, based on first label information of the segmentation image and a user's input; and updating the separated mesh model, based on the updated second label information, in which an integrated mesh model before being separated into an object unit is generated from the image sequence.

The separation method may include mapping the separated mesh model to the first label information, based on a reprojection matrix obtained from the obtaining the separated mesh model.

The separation method may further include obtaining the second label information of the separated mesh model, based on a mapped relationship between the separated mesh model and the first label information.

The separation method may further include updating the first label information, based on the second label information and the user's input, and updating the segmentation image based on the updated first label information.

The updating the first label information may include correcting the first label information in response to the updated second label information, and the updating the second label information may include correcting the first label information in response to the updated first label information.

The segmentation image may be an output of a segmentation model trained to extract an object included in the image sequence, and the segmentation model may be trained based on the updated segmentation image.

According to another aspect, there is provided a device including: a memory including instructions; and a processor electrically connected to the memory and configured to execute the instructions, in which, when the processor executes the instructions, the processor is configured to obtain a mesh model separated into an object unit, based on a segmentation image extracting an object included in an image sequence, update second label information of the separated mesh model, based on first label information of the segmentation image and a user's input, and update the separated mesh model, based on the updated second label information, in which an integrated mesh model before being separated into an object unit is generated from the image sequence.

The processor may map the separated mesh model to the first label information, based on a reprojection matrix obtained from the obtaining the separated mesh model.

The processor may obtain the second label information of the separated mesh model, based on a mapped relationship between the separated mesh model and the first label information.

The processor may update the first label information, based on the second label information and the user's input, and update the segmentation image based on the updated first label information.

The processor may correct the first label information in response to the updated second label information and correct the first label information in response to the updated first label information.

The segmentation image may be an output of a segmentation model trained to extract an object included in the image sequence, and the segmentation model may be trained based on the updated segmentation image.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating a separation system according to various example embodiments;

FIG. 2 is a diagram illustrating a three-dimensional (3D) separation device according to various example embodiments;

FIG. 3 is a diagram illustrating an operation of updating a separated mesh model by a 3D separation device according to various example embodiments;

FIG. 4 is a diagram illustrating an operation of generating a segmentation model according to various example embodiments; and

FIG. 5 is a diagram illustrating another example of a 3D separation device according to various example embodiments.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the example embodiments with reference to the accompanying drawings, like reference numerals refer to like elements and a repeated description related thereto will be omitted.

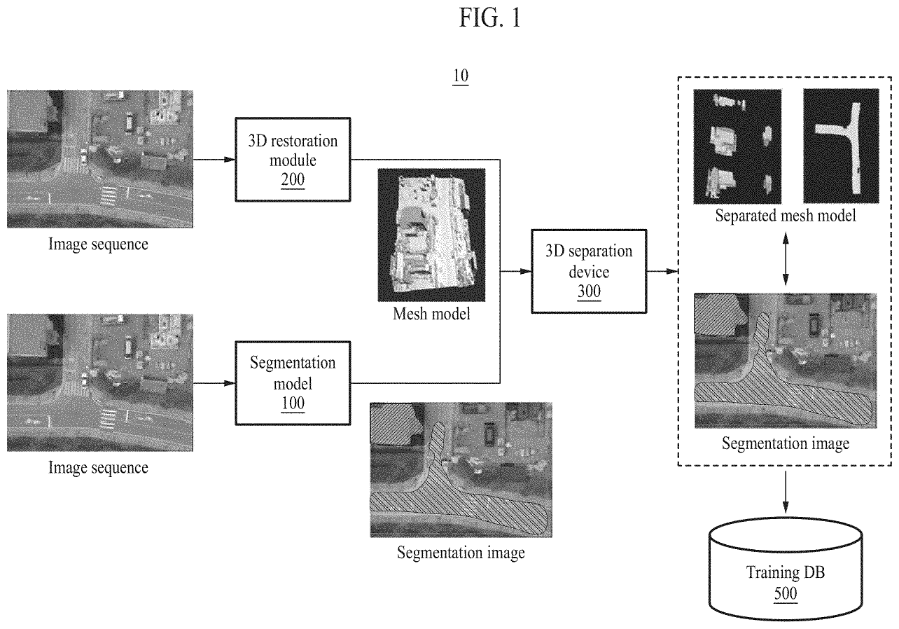

FIG. 1 is a diagram illustrating a separation system according to various example embodiments.

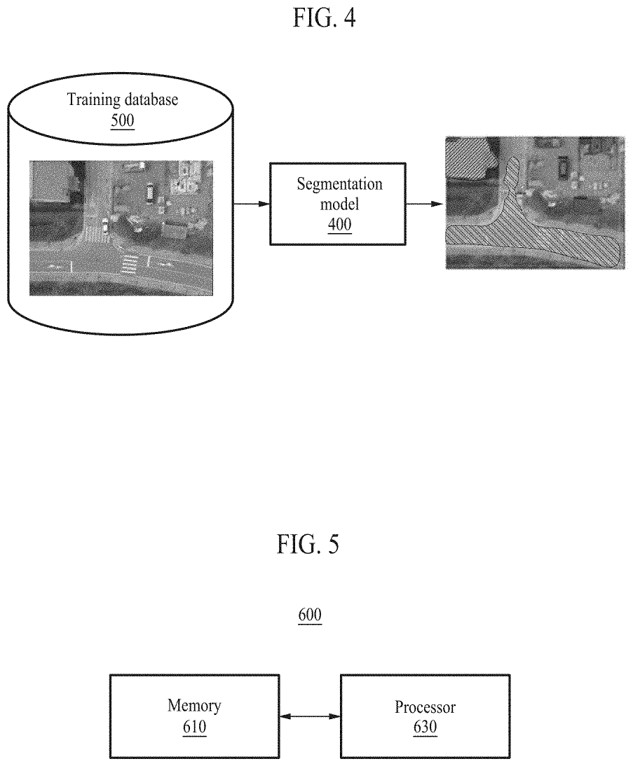

Referring to FIG. 1, a separation system 10 may include a segmentation model 100, a three-dimensional (3D) restoration module 200, a 3D separation device 300, and a training database 500. The separation system 10 may generate a mesh model of an object included in an image sequence by using each component (e.g., the segmentation model 100, the 3D restoration module 200, the 3D separation device 300, and the training database 500). The segmentation model 100 may generate a segmentation image extracting an object included in an image sequence. The segmentation model 100 may be a trained segmentation model of a segmentation model 400 of FIG. 4. The 3D restoration module 200 may generate an integrated mesh model by restoring an image sequence in 3D. The 3D separation device 300 may accurately separate a mesh model into an object unit, based on an integrated mesh model and an segmentation image. The 3D separation device 300 may provide, as training data of the segmentation model 400, a segmentation image corresponding to the separated mesh model. The training database 500 may store the segmentation image corresponding to the separated mesh model and provide, as training data of the segmentation model 400, the segmentation image corresponding to the separated mesh model.

The separation system 10 may restore a 3D mesh model from an image sequence, and then, based on a segmentation image, obtain (e.g., generate) a mesh model separated into an object unit. The separation system 10 may update the mesh model separated into an object unit, based on a user's input, and more accurately generate a mesh model separated into an object unit. Since the separation system 10 may update the separated mesh model based on the user's input, the separation system 10 may improve the quality of the separated mesh model easily and accurately.

The separation system 10 may update the segmentation image in response to the more accurately separated mesh model and provide the updated segmentation image as training data of the segmentation model 400. The segmentation model 400, by using the updated segmentation image as training data, may be trained to more accurately extract an object included in an image sequence.

Since the separation system 10 may separate a mesh model into an object unit, based on an output of the segmentation model 100, when the output of the segmentation model 100 is more accurate, the separation system 10 may more accurately separate the mesh model into an object unit.

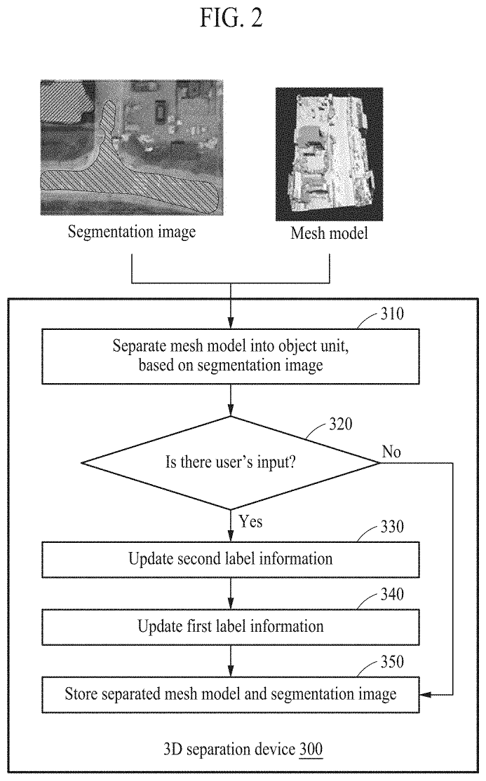

FIG. 2 is a diagram illustrating a 3D separation device according to various example embodiments.

Operations 310 through 350 may be provided to describe operations of accurately separating an integrated mesh model in an object unit by a 3D separation device 300 and generating a segmentation image corresponding to the more accurately separated integrated mesh model.

In operation 310, the 3D separation device 300 may separate an integrated mesh model, based on a segmentation image received from a segmentation model (e.g., the segmentation model 100 of FIG. 1) and an integrated mesh model received from a 3D restoration module (e.g., the 3D restoration module 200 of FIG. 1).

In operation 320, the 3D separation device 300 may map a mesh model separated from label information (e.g., first label information) of a segmentation image, based on a reprojection matrix obtained in an operation of obtaining the separated mesh model in an object unit. The 3D separation device 300 may obtain label information (e.g., second label information) of the separated mesh model, based on a mapped relationship between the separated mesh model and the first label information. The 3D separation device 300 may classify a plurality of labels included in the second label information into different groups of labels referring to the same object. The 3D separation device 300 may receive a user's input on either the first or second label information. The user's input may be an input that corrects either the first or second label information to more accurately separate an integrated mesh model in an object unit when the integrated mesh model is separated into objects between which boundaries are inaccurate. A user's input may still remain when the boundaries of the objects in the separated mesh model are inaccurate. Based on the user's input, the 3D separation device 300 may perform operations 330 and 340 to update the first and second label information. There may not be a user's input when the boundaries of the objects in the separated mesh model are accurate, and the 3D separation device 300 may update (e.g., maintain) the first and second label information to existing values of the first and second label information.

In operation 330, the 3D separation device 300 may update the second label information, based on the first label information and the user's input. The 3D separation device 300 may update (e.g., correct) the first label information by using the user's input when the user's input is on the first label information and update (e.g., correct) the second label information corresponding to the updated first label information. For example, the 3D separation device 300, by reprojecting the updated first label information to the segmentation image, may update the second label information. The 3D separation device 300 may update (e.g., correct) the second label information by using the user's input when the user's input is on the second label information. The 3D separation device 300 may update the separated mesh model based on the updated second label information. The updated separated mesh model may be a mesh model more accurately separated into an object unit than the separated mesh model before the updating.

In operation 340, the 3D separation device 300 may update the first label information, based on the second label information and the user's input. The 3D separation device 300 may update (e.g., correct) the second label information by using the user's input when the user's input is on the second label information and update (e.g., correct) the first label information corresponding to the updated second label information. The 3D separation device 300 may update (e.g., correct) the first label information by using the user's input when the user's input is on the first label information. The 3D separation device 300 may update the segmentation image based on the updated first label information. The updated segmentation image may be a segmentation image more accurately extracting an object included in an image sequence than the segmentation image before the updating.

In operation 350, the 3D separation device 300 may store the updated segmentation image and the updated separated mesh model based on the user's input. The 3D separation device 300 may output the segmentation image to a training database (e.g., the training database 500 of FIG. 1).

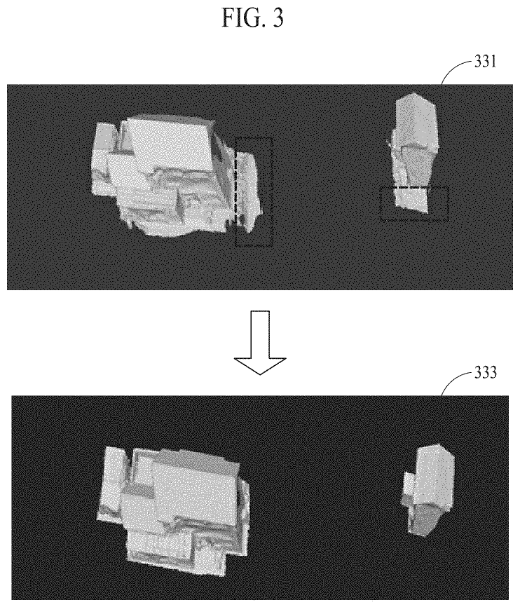

FIG. 3 is a diagram illustrating an operation of updating a separated mesh model by a 3D separation device according to various example embodiments.

Referring to FIG. 3, a first separation result 331 may be a mesh model separated into an object unit, based on a segmentation image received from a segmentation model (e.g., the segmentation model 100 of FIG. 1) by a 3D separation device (e.g., the 3D separation device 300 of FIG. 1) and an integrated mesh model received from a 3D restoration module (e.g., the 3D restoration module 200 of FIG. 1). The first separation result 331 may be a set of a mesh model of which second label information is a building and a mesh model separated with the ground on a side of the building.

The 3D separation device 300 may generate a second separation result 333 by updating a mesh model separated based on updated second label information. The 3D separation device 300 may update (e.g., correct) second label information corresponding to the ground on the side of the building from the ‘building’ to the ‘ground’, based on a user's input, and separate the building such that the mesh model includes the building only, based on the updated second label information.

FIG. 4 is a diagram illustrating an operation of generating a segmentation model according to various example embodiments.

Referring to FIG. 4, a segmentation model 400 may be generated (e.g., trained) to receive an input of an updated segmentation image and to extract an object included in the updated segmentation image. The updated segmentation image may be provided from a training database 500. Because the updated segmentation image may be updated in response to a mesh model more accurately separated by a 3D separation device (e.g., the 3D separation device 300 of FIG. 1), the segmentation model 400 may be trained to more accurately extract an object included in an image sequence by using the updated segmentation image as training data.

FIG. 5 is a diagram illustrating another example of a 3D separation device according to various example embodiments.

Referring to FIG. 5, a 3D separation device 600 may include a memory 610 and a processor 630.

The memory 610 may store instructions (e.g., a program) executable by the processor 630. For example, the instructions may include instructions for performing an operation of the processor 630 and/or an operation of each component of the processor 630.

According to various example embodiments, the memory 610 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM(CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 630 may execute computer-readable code (e.g., software) stored in the memory 610 and instructions triggered by the processor 630. The processor 630 may be a hardware data processing device having a circuit that is physically structured to execute desired operations. The desired operations may include code or instructions in a program. The hardware data processing device may include a microprocessor, a central processing unit (CPU), a processor core, a multi-core processor, a multiprocessor, an application-specific integrated circuit (ASIC), and/or a field-programmable gate array (FPGA).

According to various example embodiments, operations performed by the processor 630 may be substantially the same as the operations performed by the 3D separation device 300 described with reference to FIGS. 1 through 3. Accordingly, further description thereof is not repeated herein.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A separation method comprising:
obtaining a mesh model separated into an object unit, based on a segmentation image extracting an object included in an image sequence;
updating second label information of the separated mesh model, based on first label information of the segmentation image and a user's input; and
updating the separated mesh model based on the updated second label information,
wherein
an integrated mesh model before being separated into an object unit is generated from the image sequence.

2. The separation method of claim 1, further comprising:
mapping the separated mesh model to the first label information, based on a reprojection matrix obtained from the obtaining the separated mesh model.

3. The separation method of claim 2, further comprising:
obtaining the second label information of the separated mesh model, based on a mapped relationship between the separated mesh model and the first label information.

4. The separation method of claim 1, further comprising:
updating the first label information, based on the second label information and the user's input, and
updating the segmentation image based on the updated first label information.

5. The separation method of claim 4, wherein
the updating the first label information comprises:
correcting the first label information in response to the updated second label information,
wherein
the updating the second label information comprises:
correcting the first label information in response to the updated first label information.

6. The separation method of claim 4, wherein
the segmentation image is an output of a segmentation model trained to extract an object included in the image sequence, and
the segmentation model is trained based on the updated segmentation image.

7. A non-transitory computer-readable storage medium storing instructions that, when executed by a processor, cause the processor to perform the separation method of claim 1.

8. A device comprising:
a memory comprising instructions; and
a processor electrically connected to the memory and configured to execute the instructions,
wherein,
when the processor executes the instructions, the processor is configured to:
obtain a mesh model separated into an object unit, based on a segmentation image extracting an object included in an image sequence,
update second label information of the separated mesh model, based on first label information of the segmentation image and a user's input, and
update the separated mesh model based on the updated second label information,
wherein
an integrated mesh model before being separated into an object unit is generated from the image sequence.

9. The device of claim 8, wherein
the processor is configured to map the separated mesh model to the first label information based on a reprojection matrix obtained from the obtaining the separated mesh model.

10. The device of claim 9, wherein
the processor is configured to obtain the second label information of the separated mesh model, based on a mapped relationship between the separated mesh model and the first label information.

11. The device of claim 8, wherein the processor is configured to:
update the first label information, based on the second label information and the user's input, and
update the segmentation image based on the updated first label information.

12. The device of claim 11, wherein the processor is configured to:
correct the first label information in response to the updated second label information, and
correct the first label information in response to the updated first label information.

13. The device of claim 11, wherein
the segmentation image is an output of a segmentation model trained to extract an object included in the image sequence, and
the segmentation model is trained based on the updated segmentation image.
